(19) United States
(12) Patent Application Publication
(10) Pub. No.: US 2015/0342211 A1
(43) Pub. Date: Dec. 3, 2015

(54) USE OF UNSAPONIFIABLE EXTRACT OBTAINED FROM VEGETABLE OIL DEODORIZER DISTILLATE FOR THE STABILIZATION OF CANOLA OIL

(71) Applicants: Sherazi Tufail Hussain, Jamshoro (PK); Saba Naz, Jamshoro (PK)

(72) Inventors: Sherazi Tufail Hussain, Jamshoro (PK); Saba Naz, Jamshoro (PK)

(21) Appl. No.: 14/289,373

(22) Filed: May 28, 2014

(51) Int. Cl. A23D 9/06; A23D 9/007

(52) U.S. Cl. CPC A23D 9/06; A23D 9/007

(57) ABSTRACT

The invention relates to a process for the stabilization of canola oil by a more reliable and rapid method for the evaluation of oxidative stability in oil. Results revealed that induction time for 200 ppm UE is greater than 200 ppm BHA which indicates that UE of DDVO was more potent than that of BHA.

### BACKGROUND OF THE INVENTION

Oils and fats derived from plants are in the form of esters, resulting from a combination of three fatty acids molecules with glycerol backbone. The fatty acids attached to glycerols are long chain hydrocarbons (8-24 carbon units).

The oil and fats are familiar as a vital part of human diet. Vegetable oil and fat are also used as a raw material in pharmaceutical, cosmetics and food. Stability, quality and nutritional value are the main parameters that have effects on the commercial values of the oils.

Quality control departments of food processing industries are performing more effort in maintaining the oil quality parameters to increase its market value. Vegetable oil and fats are more vulnerable to oxidization in an oxygen atmosphere which instantaneously initiates the deterioration process. Consequently it diminishes the nutritive value, oil shelf life as well as oil consistency and color. Due to these unwanted modifications in oil and fat, customers do not agree to consume oxidative damage products and hence manufactures face enormous financial losses. Oils with a high level of unsaturation due to the presence of mono, di, tri and polyunsaturated fatty acids are more attracted towards oxidation. Heat light, metals (mainly Cu and Fe), proxidants, enzymes and microbes are chemical agents that enhance the oxidation rate in an oil and fat. Hence, the oil may experiences auto-oxidation, thermal oxidation, enzymatic oxidation, and photosensitized oxidation).

Oxidative stability is an important property of edible oils and fats which prevent it from oxidation and preserve the stability of oil. It can be estimated as the period of time needed for the formation of secondary products of the oxidation reaction under specific condition. The time period measured is recognized as the induction period, it increases the lipid oxidation rate. Several artificial antioxidants such as BHA, butylated hydroxytoluene (BHT), ter-butyl hydroquinone (TBHQ) are used to improve the stability of oils and fats. But, synthetic antioxidants are found to be carcinogenic and hence have a great potential risk to human health. That's why, it is very important to avert the rate of lipid peroxidation in foodstuffs. Hence, application of the more potent synthetic antioxidant (TBHQ) for food additives has been banned in Japan, Canada and Europe. Similarly, BHA has also been removed from the generally recognized as safe (GRAS) list of compounds.

Customer's demand for more appropriate, safe, healthier and natural products has been increased and consequently has encouraged the investigators to ascertain some potent natural antioxidant as a substitute of synthetic oxidant. Previously many studies have been carried out to observe the efficiency of various natural sources for the stabilization of vegetable oil. However, exploration of novel research is still in progress to find out original, safe, and economical sources of antioxidants. Iqbal et al. studied the efficiency of garlic extract to evaluate the stabilization of vegetable oil against free radical damage when stored for a long period of time. Besides, it has been identified that sesame cake extract could significantly decrease the para-anisidine value, peroxide value and diene value in vegetable oil at concentrations of 5, 10, 50 and 100 ppm. It has also been revealed that sesame cake extract has shown better shielding effect from oxidation than that of BHA 200 ppm.

Moreover, phytochemical extracts (PE) which was obtained from defeated rice bran and was applied in large quantity of oil for protection and stability purpose. PE comprised of non-synthetic antioxidants like tocopherols, oryzanols, and ferulic acid. PE is comparable in efficiency with TBHQ (200 ppm) even used at high temperature but far maximum than that BHA at the same 200 ppm level.

### BRIEF SUMMARY OF THE INVENTION

Tocopherols are natural antioxidants mainly used to deactivate the free radical mechanism. According to Fröhlich & Schober, (2007) tocopherols were applied in the range of (250-2000 ppm) to prevent the fatty acid methyl ester from decomposition. Deodorized distillate is a waste product of deodorization refining process, which is considered to be the most concentrated source of various valuable components, for instance, tocopherols, tocotrienols, phytosterols (free and esterified), hydrocarbons, squalene, mono and di-glycerides, neutral oil and free fatty acids. At the present time more attention has been given to explore the recycling of waste products in addition to reducing their negative influence on the environment. Therefore, remarkable research interest has been developed for the utilization and extraction of useful bioactive compounds from the waste product of refining process mainly from deodorized distillates.

Several methods have been developed for evaluating the degree of oxidation in fat and oil. Traditionally, the Schaal Oven Test and the Active Oxygen Method (AOM) were the most commonly used tests to estimate oils stability. At present, commercially available Rancimate apparatus and the Oxidative Stability Instrument (OSI) are widely used for oxidative stability measurement. Thermo-analytical technique, such as differential scanning calorimetry (DSC), is an expedient tool to measure oxidation rate because it is fast, reliable and requires few milligrams of sample when compared to Rancimate method which needs more time and greater amount of sample for analysis. In the present work, an extracted unsaponifiable fraction of deodorized distillates obtained from vegetable oil was used as a natural antioxidant rich material for the stabilization of refined bleached and deodorized canola oil.

### BRIEF DESCRIPTION OF THE DRAWINGS

FIG. 1. depicts a representative differential scanning calorimetry oxidation thermogram of control sample at isothermal temperature 120° C.: (A) with nitrogen (99.99%) at flow rate 50 ml/min; and (B) with oxygen (99.99%) at flow rate 50 ml/min.

FIG. 2. depicts DSC profile of RBD canola oil sample after addition of 100 ppm to 900 ppm of UE at 120° C.

FIG. 3. depicts the correlation plot of average data values of T₀ versus OSI.

### DETAILED DESCRIPTION OF THE INVENTION

Deodorized distillates of sunflower oil produced during the deodorization process were obtained from edible oil industries located in Karachi, Pakistan. Refine, bleached and deodorized (RBD) Canola oil without the addition of antioxidants obtained from the same edible oil industry. All samples were stored in the refrigerator at 4° C. until analyzed. All chemicals and solvents were of analytical grade acquired from Fisher Scientific UK Ltd.

DDVO sample (30 g) was taken into 250 ml round bottom flask. Originally the sample was purged under nitrogen atmosphere. A given amount of the sample was then saponified with 150 ml of ethanolic potassium hydroxide (KOH) at constant temperature of 80° C. for about 60 min. After saponification, samples were allowed to cool at room temperature and extracted with 80 ml of n-hexane three times. Pooled hexane layer was evaporated under the stream of nitrogen, which yields 6.8 g of unsaponifiable fraction.

Primarily RBD canola oil without the addition of synthetic antioxidant (BHA) was used as a control. Samples for stability analysis were prepared in concentrations ranged from 100 ppm to 900 ppm in RBD canola oil by adding different amount of UE of DDVO. RBD Canola oil with 200 ppm of BHA was also prepared for correlation test with UE.

The oxidative stability of prepared samples oils was determined by performing an experiment on a Mettler Toledo DSC-822. The instrument was calibrated with pure indium metal, (m.p. 156.6° C.) according to the established standard procedure and the baseline was obtained with an empty aluminum ampule airtight with pierced concealment. The samples of (5.0±0.5 mg) were accurately weighed into an open aluminum ampule of 40 μL. The ampule was then enclosed with pierced lid so that the air stream directly interacted with the oil sample through pierced hole.

Another empty aluminum ampule sealed with pierced cover was used as a reference. Samples and reference were positioned into the instrument's sample and reference holder. Overall analysis was carried out isothermally at a temperature of 120° C. and under purified oxygen (99.8%) atmosphere 50 ml/min for purging. When the run was finished, the sample's induction time (T₀) of the oxidative reaction was calculated by the intersection of the extrapolated baseline and the tangent line (leading edge) of the DSC thermogram.

An automated Rancimate instrument from Metrohm, model 679 was used to evaluate the oxidative stability indexes by following the American Oil Chemists' Society (AOCS) Official Method Cd 12b-92 (AOCS 1997). The stability experiments were performed with 2.00±0.01 g of samples at 110° C., and flow rate of air was 20 L/h. Increasing conductivity of water due to volatile oxidation products was continuously monitored while the air was bubbled into the sample at a constant temperature of 110° C. The time taken to reach the conductivity inflection time was recorded.

All the analyses were done three times and reported as an average of the replicate results. PASW statistics 18 software was used for the statistical evaluation of data. Analysis of variance (ANOVA) and Fisher's Least Significant difference (LSD) were performed for comparison of mean values at P<0.05.

Gas chromatography-mass spectrometry (GC-MS) was used for the analytical characterization of unsaponifiable fraction of deodorized distillates sample. The results achieved by GCMS for the chemical composition of unsaponifiable fraction are an average of triplicate measurements with their relative standard deviation (R.S.D) and retention times (Rt) presented in Table 1.

TABLE 1
GC-MS data of unsaponifiable fraction
of sunflower oil deodorizer distillate.

| | Rt | Concentration | R.S.D |
|---|---|---|---|
| Components | (min) | (g/100 g) | (%) |
| Octacosane | 6.25 | 0.75 | 1.33 |
| 1,13-Tetradecadiene | 6.52 | 1.09 | 0.09 |
| Triacontane | 7.26 | 2.39 | 1.25 |
| Octadecane | 7.76 | 1.91 | 1.04 |
| Squalene | 7.92 | 10.60 | 0.28 |
| Nonacosane | 8.22 | 4.74 | 1.26 |
| Stigmastan-3,5,22-trien | 9.05 | 4.16 | 1.68 |
| Tetratriacontane | 9.21 | 5.70 | 0.70 |
| Stigmastan-3,5-diene | 9.42 | 6.42 | 0.31 |
| Vitamin E | 9.50 | 3.81 | 0.03 |
| Campesterol | 10.24 | 8.35 | 0.25 |
| Stigmasterol | 10.47 | 8.33 | 1.44 |
| β-Sitosterol | 11.00 | 26.03 | 0.08 |
| Stigmast-7-en-3-ol | 11.48 | 6.83 | 1.75 |
| Cycloartenol | 11.63 | 3.29 | 0.30 |
| alpha.-Amyrin | 11.73 | 5.58 | 0.03 |

Each value is a mean of three measurement (n = 3)

It was observed that varying amounts of phytosterols, tocopherols, squalene and other hydrocarbons contained in DD. Maximum percentage of sterols found in the deodorized distillates followed by hydrocarbons and Vitamin E. Phytosterols are natural bioactive compounds play major roles in numerous areas, appreciably in pharmaceuticals (production of steroidal drugs), nutritional (use in functional foods for cholesterol lowering additive, anticarcinogenic), and cosmetics (use in creams, makeup foundation). Phytosterols have the ability to reduce cholesterol absorption from the intestine and thereby are known to have cholesterol-lowering effect in blood as well.

Moreover, phytosterols may possess antioxidant activities. Tocopherols are also called vitamin E is an excellent free radical scavenger that inhibits the amount of oxidation reaction. Due to their antioxidant property they are widely used as food additives. The vegetable oil deodorizer distillate is a rich and cheap source of tocopherols and their concentration in deodorized distillates is in the range of 2-10%.

β-sitosterol was found to be the major component in the DDVO in high concentration (26.03%) relative to other constituents. Other components include squalene (10.60%), campesterol (8.33%), stigmasterol (8.35%), Vitamin E (3.81%), Stigmast-7-en-3-ol (6.83%) Stigmastan-3,5-diene (6.42%), Tetratriacontane (5.70%), alpha.-Amyrin (5.58%), Nonacosane (4.75%), Stigmastan-3,5,22-trien (4.16%) Cycloartenol (3.29%), Triacontane (2.39%), Octadecane (1.91%), 1,13-Tetradecadiene (1.09%) and Octacosane (0.75%).

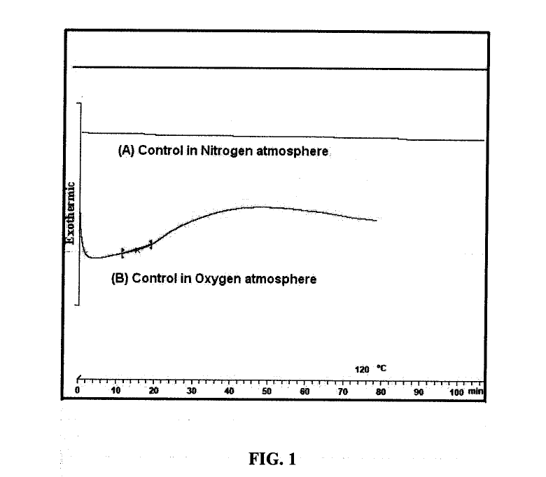

The measurement of oil or fat's ability to resist the oxidation reaction is called oxidative stability. Since oxidation is an exothermic process and time required for slow oxidation process before they speed up is noted as an induction time. The evaluation of oxidative stability by DSC was calculated by the induction time with the help of exothermal curves. In the presence of an inert atmosphere under a stream of pure nitrogen (99.99%) straight line was observed as shown in FIG. 1.A. The flow rate and temperature of Nitrogen was 50 ml/min and 120° C. respectively. From the straight line it is clear that no oxidation reaction occurred in nitrogen atmosphere. Whereas when pure oxygen (99.99%) is supplied to the control sample under the same temperature and flow rate an exothermic curve was observed as represented in FIG. 1.B.

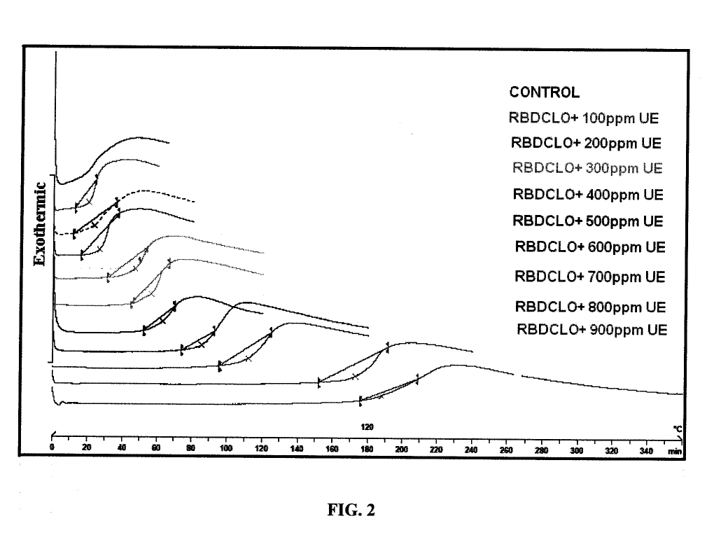

A clear DSC profile of RBD canola oil with and without added unsaponifiable extract is shown in FIG. 2. Oxidative stability test was performed by adding various concentrations of unsaponifiable extract in RBD canola oil containing no any preservatives (control). Samples were prepared in the range of 100 ppm to 900 ppm. An additional treatment of BHA at 200 ppm concentration was used to compare the oxidative stability of synthetic antioxidants against natural antioxidants.

Samples and control were heated under constant conditions of DSC at 120° C. isothermal temperature, an air flow of 50 ml/min and for Rancimate method 110° C. temperature with aeration of 20 L/h respectively. Oxidative deterioration of vegetable oils effects on the relative stability of oil and can directly be estimated through induction periods (To) (Coppin & Pike, 2001). All the samples containing unsaponifiable extract and artificial antioxidant established noticeably higher induction periods related to that of the control sample. Average values of Tₒ and OSI times with standard deviation are presented in Table 2.

TABLE 2
Induction time estimated by differential scanning calorimetry (DSC)
and oxidative stability index (OSI) of canola oil containing unsaponifiable
extract (UE) of deodorizer distillate from sunflower oil.

| Sample | DSC | CV | | OSI | CV | |
|---|---|---|---|---|---|---|
| concentration (ppm) | (Tₒ min) ± SD | (%) | SF | (Tₒ min) ± SD | (%) | SF |
| Control | 18.04 ± 0.01 | 0.03 | — | 60.05 ± 0.35 | 0.58 | — |
| RBDCLO + 100 ppm UE | 20.04 ± 0.03 | 0.15 | 1.11 | 85.36 ± 0.02 | 0.02 | 1.42 |
| RBDCLO + 200 ppm BHA | 28.01 ± 0.02 | 0.06 | 1.55 | 120.68 ± 0.06 | 0.05 | 2.01 |
| RBDCLO + 200 ppm UE | 24.08 ± 0.04 | 0.18 | 1.34 | 100.73 ± 0.17 | 0.16 | 1.68 |
| RBDCLO + 300 ppm UE | 47.54 ± 0.02 | 0.04 | 2.64 | 179.96 ± 0.03 | 0.02 | 2.99 |
| RBDCLO + 400 ppm UE | 57.74 ± 0.01 | 0.02 | 3.20 | 210.24 ± 0.14 | 0.06 | 3.50 |
| RBDCLO + 500 ppm UE | 64.08 ± 0.02 | 0.03 | 3.55 | 230.43 ± 0.21 | 0.09 | 3.84 |
| RBDCLO + 600 ppm UE | 86.14 ± 0.06 | 0.07 | 4.77 | 288.38 ± 0.37 | 0.13 | 4.80 |
| RBDCLO + 700 ppm UE | 113.26 ± 0.06 | 0.06 | 6.28 | 347.76 ± 0.17 | 0.05 | 5.79 |
| RBDCLO + 800 ppm UE | 172.43 ± 0.01 | 0.01 | 9.56 | 498.55 ± 0.29 | 0.06 | 8.30 |
| RBDCLO + 900 ppm UE | 188.32 ± 0.05 | 0.03 | 10.44 | 556.84 ± 0.08 | 0.01 | 9.27 |

The results are expressed as an average of three data points (n = 3) ± S.D, (p < 0.05)

The standard deviation in the entire samples was not greater than 0.06 and 0.37 in the case of Tₒ and OSI respectively. The Tₒ values ranged from 18.04 to 188.32 min while OSI values were obtained in the range of 60.05 to 556.84 min. However the coefficient of variation for Tₒ varied between 0.01 to 0.18% and for OSI 0.01 to 0.58% as given in Table 2. Significantly (p<0.05) lower induction times were achieved by running the sample on DSC than the OSI times obtained through Rancimate instrument.

These results are in agreement with those determined by Tan et al. (2002) who suggested that these variations in induction times may be due to relatively lower amount of sample (3-5 mg) used in DSC experiments as compared to the Rancimate which require at least 5 g of sample. Surface to volume ratio between the oxidant (oxygen) and sample (oil) is another important factor described by Tan et al (2002).

The smaller quantity of sample desirable for DSC analysis has a high surface to volume ratio than the sample in a test tube used for Rancimate method. Usually induction time measurement by DSC used pure oxygen as an oxidant and Rancimate analyses carried out in the presence of air which consist of almost 21% oxygen in its composition. Therefore isothermal DSC has many benefits over the other oxidative stability methods like Rancimate and Schall oven test. For instance, oil samples which need 14 days by Schall oven method could be assessed by DSC in less than one hour. The DSC onset oxidation time of control was noted at 18.04 min when heated at 120° C.

However significantly increase in induction times noted by the addition of 100 ppm UE of DDVO which shifts the induction times to 20.04 min. It confirms that the presence of antioxidants improves the stability of canola oil. Besides, synthetic antioxidant BHA was also tested for evaluation of comparative effectiveness to that of UESFDD. The oil sample containing 200 ppm UESFDD and 200 ppm BHA resulted induction periods at 24.04 min and 28.00 min respectively. These results showed that even at the same concentration UESFDD is more proficient in protecting the oil to a great extent as compared to BHA at the same 200 ppm concentration. These results are in good agreement with Abd-ElGhany, Ammar & Hegazy, (2010) who reported that the olive oil waste cake could be effective for stabilization of vegetable oil at 200 ppm level or higher concentrations as compared to BHT at its legal limit. Ordinarily, vegetable oils with higher level of unsaturation are more prone to lipid oxidative deterioration. Therefore, RBD canola oil (control) showed significantly lower induction time than the RBDCLO+100 ppm UE.

The stability effect of various antioxidants at different concentrations can be evaluated with the help of stabilization factor (SF) which can be defined as the ratio between the induction periods of sample with antioxidants (IP_{A}) and the induction of sample without antioxidants (IP₀). The stabilization factor is expressed as:

SF=IP_{A}/IP₀

### (Focke, Westhuizen, Grobler, Nshoane, Reddy, & Luyt, 2012)

Consequently, a higher value of induction time imitates a higher stabilization factor that in turn is related with higher stability of canola oil treated with maximum antioxidant concentration. Comparatively similar values of SF obtained by both DSC and Rancimate methods. SF values for all the samples have been given in Table 2. The SF of each tested sample given in parenthesis were followed the order RBDCLO+100 ppm UE (1.11)<RBDCLO+200 ppm BHA (1.34)<RBDCLO+200 ppm UE (1.55)<RBDCLO+300 ppm UE (2.64)<RBDCLO+400 ppm UE (3.20)<RBDCLO+500 ppm UE (3.55)<RBDCLO+600 ppm UE (4.77)<RBDCLO+700 ppm UE (6.28)<RBDCLO+800 ppm UE (9.56)<RBDCLO+900 ppm UE (10.44).

It is clear that stability enhances with the maximum level of added unsaponifiable extract proposing a substantial utility of DDVO extract at all concentration on the oxidative stability of canola oil. SF value of 100 ppm UE (1.11) stabilized canola oil was higher than that of soybean oil stabilized with 200 ppm level of crude methyl extract of rice bran (0.48), tocopherols mixture (0.47), acetone extracted lipophilic portion of rice bran (0.70), acetone extracted polar fraction (0.72), phytochemicals of extracted rice bran including oryzanol (0.12) ferulic acids (0.38) β-Sitosterol (0.08) and relatively similar efficiency was professed at 200 ppm level of TBHQ (1.09).

Previously many studies have been carried out to evaluate the oxidative stability of edible oils by using various plant extracts which contain beneficial natural antioxidants. Suja et al., investigated the antioxidant activity of sesame cake extract added in vegetable, soybean and safflower oil at 5, 10, 50 and 100 ppm level was more effective than the BHT at 200 ppm level. But when comparing induction times T₀ to our results it indicated that the stability effect of unsaponifiable extract of DDVO was greater at the 100 ppm level (18.04 min) than the sesame cake extract at the same level of 100 ppm (6.93 min). This remarkable higher stabilization activity of unsaponifiable extract of vegetable distillate may be explained by the presence of enriched levels of endogenous natural antioxidants like tocopherols as characterized by our previous work.

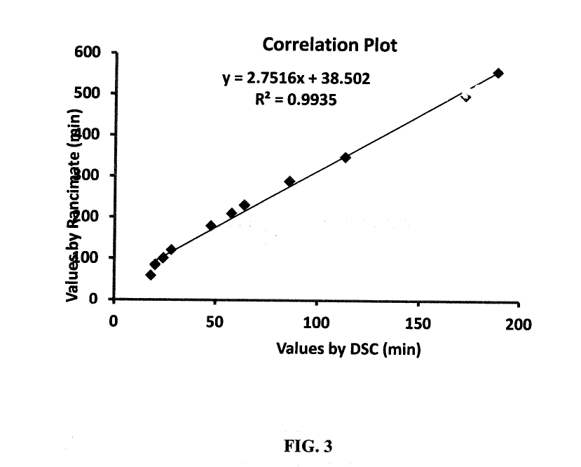

Correlation plot has been developed to estimate the degree of linear relationship between the results of DSC and OSI methods and Pearson correlation coefficient have been calculated which describes the degree of linearity between two variables. The correlation coefficient values range from −1 to +1. If both variables are increasing at the same order the correlation coefficient is positive whereas, if directions of both variables are in opposite order the correlation is negative. A Linear correlation model is depicted in (FIG. 3) which represent the good correlations (R=0.993) found between the results of DSC T₀ and Rancimat analysis. It specified that analysis by DSC could be used as the rapid analytical technique when compared to the Rancimate. Due to ease of use, and minimal sample amount the DSC could be used as a rapid routine thermal analytical method for oxidative stability measurement.

From the present work, it is concluded that unsaponifiable portion of vegetable deodorized distillates, more particularly sunflower oil, stabilized the canola oil to a greater extent than the BHA synthetic antioxidant. The efficiency of inhabitation appreciably increased by high level of unsaponifiable extract added in canola oil. Since recent interest has been developed towards safe and natural products, unsaponifiable extract of deodorized distillates could be used as an alternative natural source of antioxidants. Furthermore by proper care, treatment, and utilization of waste products from edible oil refineries, an industrialist can reduce the environmental pollution as well as contribute for economic benefits.

What is claimed is:

1. A method of stabilizing oils by adding a sufficient quantity of unsaponifiable extract from deodorized distillate of vegetable oils.

2. The method of claim 1, wherein the quantity of the unsaponifiable extract ranges 10 to 1000 ppm.

3. The method of claim 1, wherein the vegetable oil is sunflower oil.
